(19) United States
(12) Patent Application Publication
(10) Pub. No.: US 2017/0340122 A1
(43) Pub. Date: Nov. 30, 2017

(54) Shade with Pocket System and Method of Use

(71) Applicant: Ledge Lounger Inc., Brookshire, TX (US)

(72) Inventors: Christopher Anderson, Brookshire, TX (US); Dylan Schrader, Brookshire, TX (US)

(21) Appl. No.: 15/610,330

(22) Filed: May 31, 2017

Related U.S. Application Data
(60) Provisional application No. 62/343,225, filed on May 31, 2016.
(60) Provisional application No. 62/343,166, filed on May 31, 2016.

(51) Int. Cl. A47C 7/66; A47C 1/14; A47C 7/72; F16C 11/04

(52) U.S. Cl. CPC A47C 7/66; F16C 11/04; A47C 1/143; A47C 1/146; A47C 7/72

(57) ABSTRACT

A chair assembly is disclosed. Said chair assembly comprises a shade, a chair, a hinge assemblies and an upper frame extensions. Said hinge assemblies comprises a first hinge assembly and a second hinge assembly. Said shade comprises a canopy assembly, a pocket and a frame assembly. Said hinge assemblies comprises a hinge slider and base assemblies and a hinge socket. Said hinge socket selectively rotates on said hinge bases so as to move said canopy assembly in a range of linear positions. Said frame assembly comprises said hinge socket. Said canopy assembly comprises a top surface, a bottom surface and said pocket.

### CROSS-REFERENCE TO RELATED APPLICATIONS

This application claims benefit to U.S. Patent Application Nos. 62/343,225 filed on May 31, 2016 and 62/343,166 filed on May 31, 2016.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

Prior art known to the Applicant includes U.S. Pat. No. 3,316,581 A, U.S. Pat. No. 4,384,857 A, U.S. Pat. No. 5,415,316 A, and U.S. Pat. No. 8,506,010 B2.

None of the known inventions and patents, taken either singularly or in combination, is seen to describe the instant disclosure as claimed.

### BRIEF SUMMARY OF THE INVENTION

A chair assembly is disclosed. Said chair assembly comprises a shade, a chair, a hinge assemblies and an upper frame extensions. Said hinge assemblies comprises a first hinge assembly and a second hinge assembly. Said shade comprises a canopy assembly, a pocket and a frame assembly. Said hinge assemblies comprises a hinge slider and base assemblies and a hinge socket. Said hinge socket selectively rotates on said hinge bases so as to move said canopy assembly in a range of linear positions. Said frame assembly comprises said hinge socket. Said canopy assembly comprises a top surface, a bottom surface and said pocket.

A chair assembly is disclosed. Said chair assembly comprises a shade, a chair, a hinge assemblies and an upper frame extensions. Said hinge assemblies comprises a first hinge assembly and a second hinge assembly. Said shade comprises a canopy assembly, a pocket and a frame assembly. Said canopy assembly comprises a one or more sleeves. Said canopy assembly is attached to said adjustable arms with said one or more sleeves. Said hinge assemblies comprises a hinge slider and base assemblies and a hinge socket. Said hinge slider and base assemblies comprises a hinge bases and a sliding socket. Said sliding socket is configured to selectively slide on said upper frame extensions so as to extend or compress said shade relative to said chair. Said hinge socket selectively rotates on said hinge bases so as to move said canopy assembly in a range of linear positions. Said frame assembly comprises a first side frame and a second side frame. Said frame assembly comprises an arched shape. Said frame assembly comprises said hinge socket. Said frame assembly selectively rotates on said hinge socket. Said canopy assembly selectively attaches to said frame assembly and provides a selectively configured shade. Said canopy assembly comprises a top surface, a bottom surface and said pocket. Said canopy assembly. Said pocket selectively receives a thin computer for viewing and storage below on said bottom surface. Said pocket is partially translucent.

### BRIEF DESCRIPTION OF THE SEVERAL VIEWS OF THE DRAWING

FIG. 1 illustrates a perspective overview view of a chair assembly 100.

FIG. 2A illustrates an elevated front side view of a chair assembly 100.

FIG. 2B illustrates an elevated top side view of a chair assembly 100.

FIG. 3A illustrates an elevated front side view of a first position 300a.

FIG. 3B illustrates an elevated front side view of a second position 300b.

FIG. 3C illustrates an elevated front side view of a third position 300c.

FIG. 4A illustrates an elevated front side view of a first position 400a.

FIG. 4B illustrates an elevated front side view of a second position 400b.

FIG. 5A illustrates a perspective overview view of a first position 300a.

FIG. 5B illustrates a perspective overview view of a second position 300b.

FIG. 5C illustrates a perspective overview view of a third position 300c.

FIG. 6A illustrates a perspective bottom side view of a shade 102.

FIG. 6B illustrates a perspective overview view of a frame assembly 602.

FIG. 7 illustrates a perspective overview view of a frame assembly 602.

FIG. 8 illustrates a perspective overview of a shade system diagram 800.

FIG. 9A illustrates an elevated bottom side view of a canopy assembly 108.

FIG. 9B illustrates an elevated top side view of a canopy assembly 108.

FIG. 10A illustrates an elevated bottom side view of a canopy assembly 108.

FIG. 10B illustrates an elevated front side view of a canopy assembly 108 in a first cross-section.

FIG. 10C illustrates an elevated front side view of a canopy assembly 108 in a second cross-section.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

These parts are illustrated in the figures and discussed below:
a chair assembly 100
a shade 102
a chair 104
a hinge assemblies 106
a first hinge assembly 106a
a second hinge assembly 106b
a canopy assembly 108
a pocket 110
an upper frame extensions 112
a first upper frame extension 112a
a second upper frame extension 112b
a top surface 114
a bottom surface 116
a top surface 118
a bottom surface 120
a solar panels 202
a first panel 202a
a second panel 202b
a third panel 202c
a first side 204a
a second side 204b
a first side 206a
a second side 206b
a first position 300a
a second position 300b
a third position 300c
a range of angular positions 302
a first position 302a
a second position 302b
a third position 302c
a first position 400a
a second position 400b
a range of linear positions 402
a first position 402a
a second position 402b
a moisture resistant fabric 500
a hinge slider and base assemblies 600
a first hinge slider and base assembly 600a
a second hinge slider and base assembly 600b
a frame assembly 602
a first side frame 602a
a second side frame 602b
a hinge socket 604
a first side hinge socket 604a
a second side hinge socket 604b
a hinge bases 606
a first hinge base 606a
a second hinge base 606b
a sliding socket 608
a first sliding socket 608a
a second sliding socket 608b
a thin computer 702
a shade system diagram 800
a solar panels 802
a batteries 804
a recharging system 806
a Bluetooth receiver 808
a speakers 810
a first speaker 810a
a second speaker 810b
a power switch 812
a controller assembly 814
a controller 816
a clasp 902
a pocket stitching 904
a one or more sleeve stitchings 906
a first sleeve stitching 906a
a second sleeve stitching 906b
a one or more sleeves 908
a first sleeve 908a
a second sleeve 908b
a one or more speaker pockets 1002
a first speaker pocket 1002a
a second speaker pocket 1002b
a controller pocket 1004

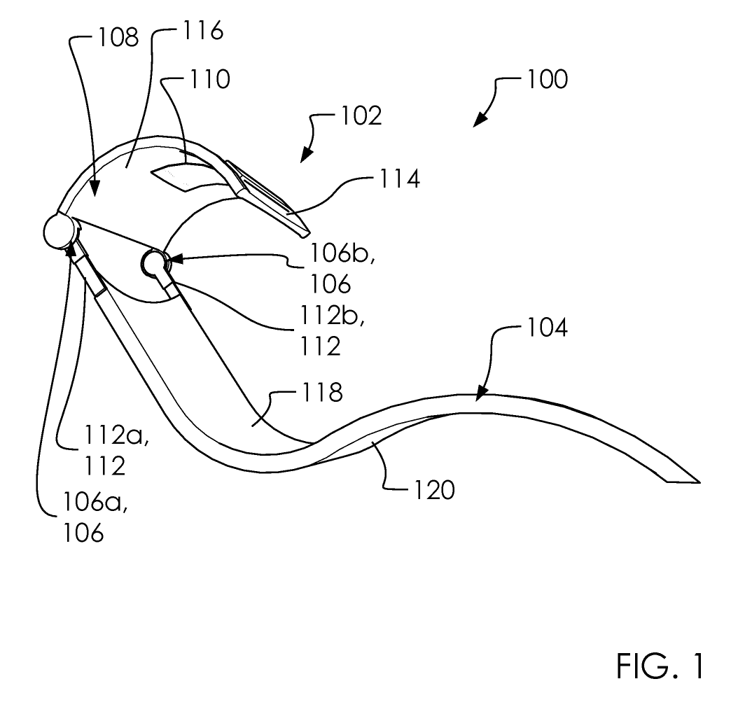

FIG. 1 illustrates a perspective overview view of a chair assembly 100.

In one embodiment, said chair assembly 100 can comprise said shade 102, said chair 104 and said hinge assemblies 106.

In one embodiment, said shade 102 can comprise said canopy assembly 108 and said pocket 110.

In one embodiment, said chair 104 can comprise said upper frame extensions 112, said top surface 118 and said bottom surface 120.

In one embodiment, said hinge assemblies 106 can comprise said first hinge assembly 106a, said second hinge assembly 106b and said upper frame extensions 112.

In one embodiment, said canopy assembly 108 can comprise said pocket 110, said top surface 114 and said bottom surface 116.

In one embodiment, said upper frame extensions 112 can comprise said first upper frame extension 112a and said second upper frame extension 112b.

In one embodiment, said chair assembly 100 can comprise a shade 102 and a chair 104 being rotateably attached to one another with a hinges 106. In one embodiment, said shade 102 can comprise a canopy 108 and a pocket 110. Further, said shade 102 can attach to said chair 104 with an adjustable arms 112. Said hinges 106 can comprise a first hinge 106a and a second hinge 106b. Likewise, said adjustable arms 112 can comprise a first arm 112a and a second arm 112b. Said canopy 108 can comprise a top surface 114 and a bottom surface 116. Said chair 104 can comprise a top surface 118 and a bottom surface 120.

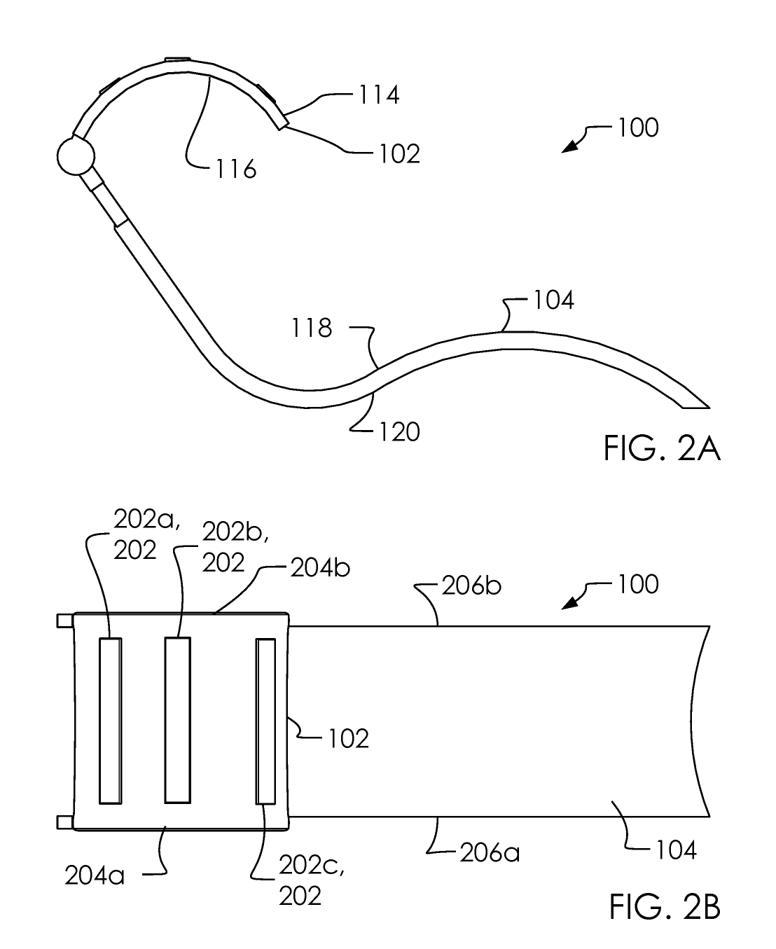

FIG. 2A illustrates an elevated front side view of a chair assembly 100.

FIG. 2B illustrates an elevated top side view of a chair assembly 100.

In one embodiment, said solar panels 202 can comprise said first panel 202a, said second panel 202b and said third panel 202c.

In one embodiment, said shade 102 can comprise said solar panels 202, said first side 204a and said second side 204b.

In one embodiment, said chair 104 can comprise said first side 206a and said second side 206b.

In one embodiment, said canopy assembly 108 can comprise said solar panels 202.

In one embodiment, said solar panels 202 can be used to provide a power source for items attached to a portion of said chair assembly 100. For example, in one embodiment, a device can be attached within said pocket 110 and powered, at least partially, with said solar panels solar panels 202.

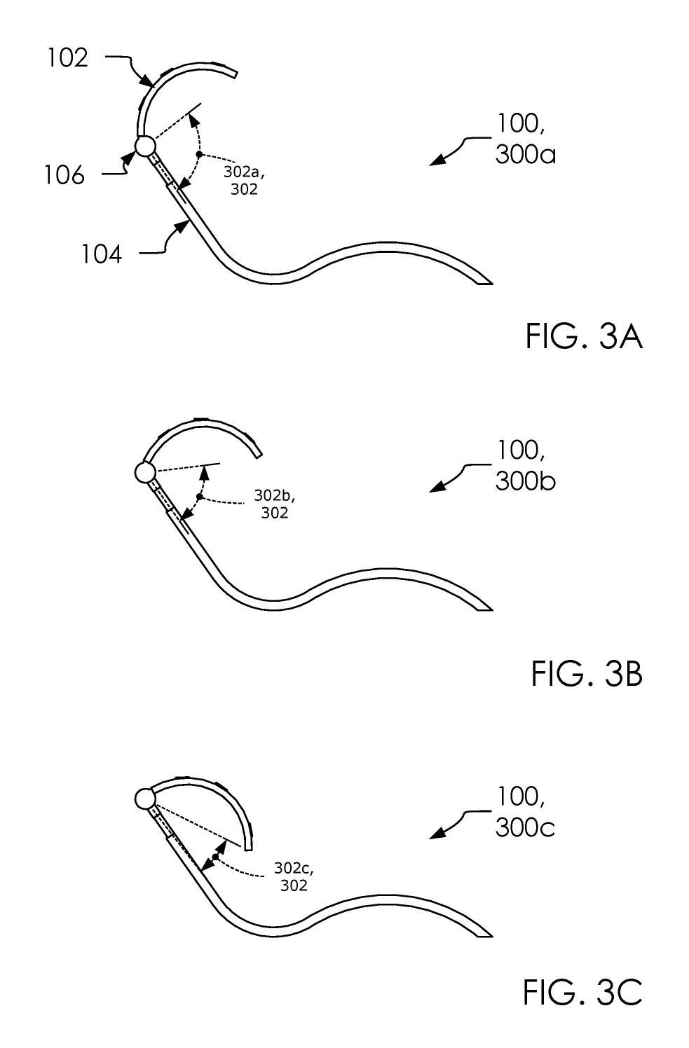

FIG. 3A illustrates an elevated front side view of a first position 300a.

FIG. 3B illustrates an elevated front side view of a second position 300b.

FIG. 3C illustrates an elevated front side view of a third position 300c.

In one embodiment, said range of angular positions 302 can comprise said first position 302a, said second position 302b and said third position 302c.

In one embodiment, said hinge assemblies 106 can comprise said first position 300a, said second position 300b, said third position 300c, said range of angular positions 302, said first position 302a, said second position 302b and said third position 302c.

With said chair assembly 100 in said first position 300a a user might be attempting to keep said shade 102 out of the way; with said shade 102 in said second position 300b, said shade 102 can be used for normal shade; and with said shade 102 in said third position 300c, said shade 102 can be used to block out substantially all light from above said shade 102. The arrangement of said third position 300c can be useful for reading an electronic device in said pocket 110, as discussed more to come.

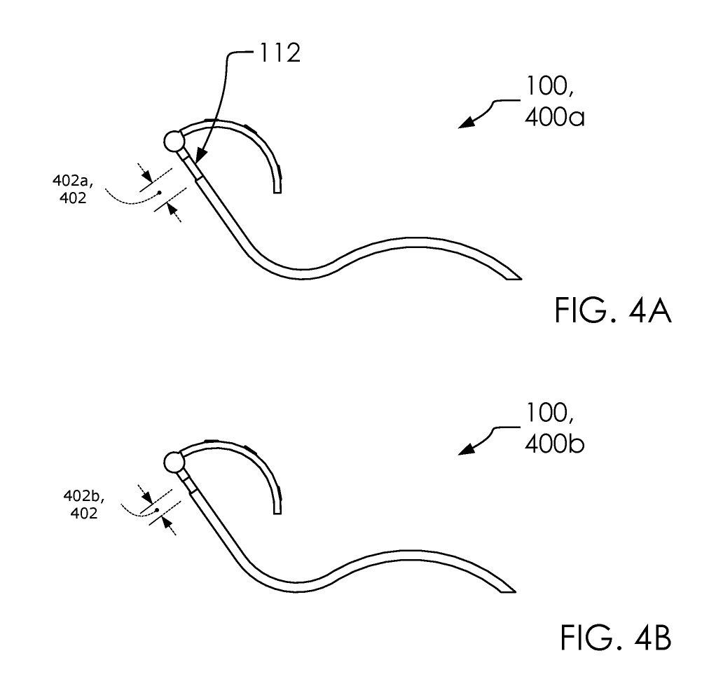

FIG. 4A illustrates an elevated front side view of a first position 400a.

FIG. 4B illustrates an elevated front side view of a second position 400b.

In one embodiment, said range of linear positions 402 can comprise said first position 402a and said second position 402b.

In one embodiment, said hinge assemblies 106 can comprise said first position 400a, said second position 400b, said range of linear positions 402, said first position 402a and said second position 402b.

In one embodiment, said shade 102 can therefore be adjusted about said adjustable arms 112 and said hinges 106.

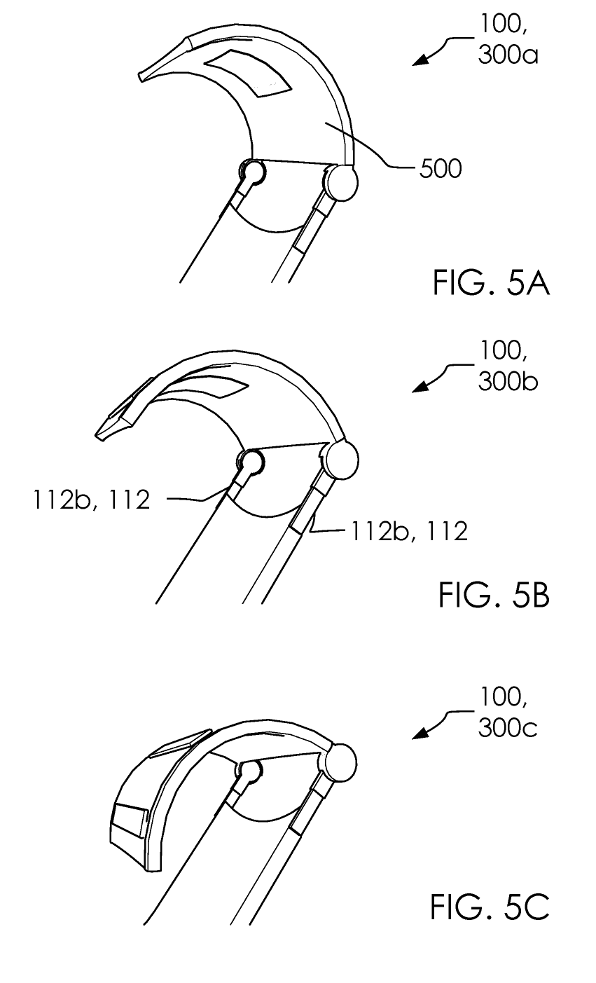

FIG. 5A illustrates a perspective overview view of a first position 300a.

FIG. 5B illustrates a perspective overview view of a second position 300b.

FIG. 5C illustrates a perspective overview view of a third position 300c.

In one embodiment, said canopy assembly 108 can comprise said moisture resistant fabric 500.

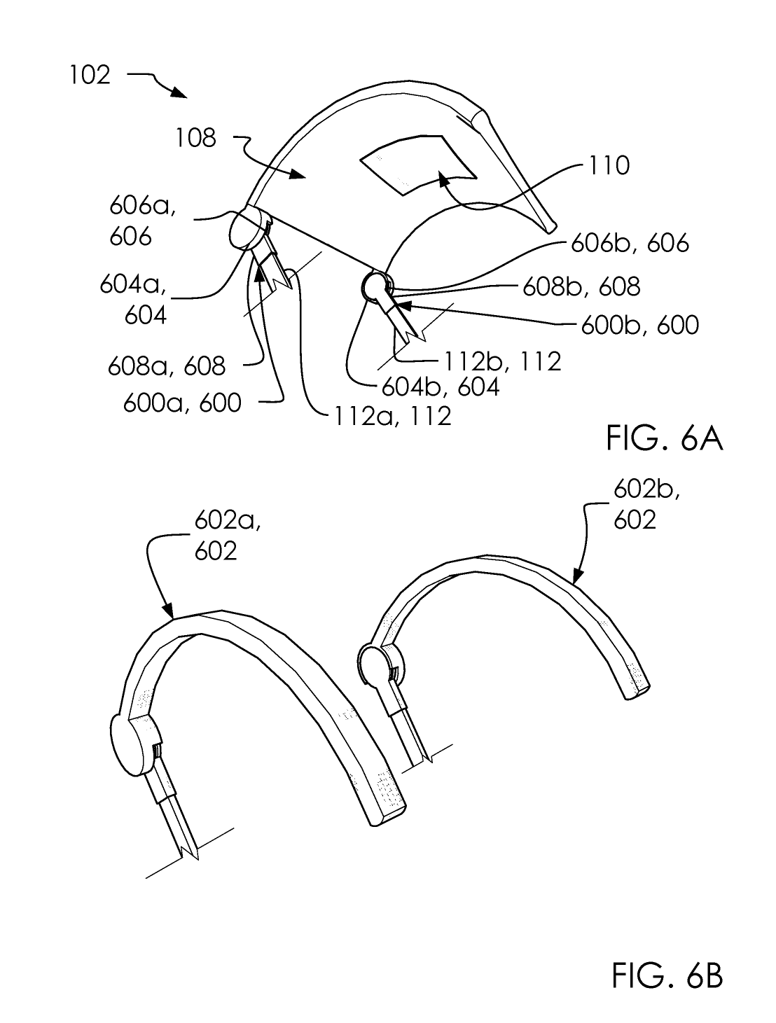

FIG. 6A illustrates a perspective bottom side view of a shade 102.

FIG. 6B illustrates a perspective overview view of a frame assembly 602.

In one embodiment, said frame assembly 602 can comprise said first side frame 602a and said second side frame 602b.

In one embodiment, said hinge socket 604 can comprise said first side hinge socket 604a and said second side hinge socket 604b.

In one embodiment, said hinge slider and base assemblies 600 can comprise said first hinge slider and base assembly 600a, said second hinge slider and base assembly 600b, said second hinge slider and base assembly 600b, said hinge bases 606, said second hinge base 606b and said sliding socket 608.

In one embodiment, said hinge bases 606 can comprise said first hinge base 606a and said second hinge base 606b.

In one embodiment, said sliding socket 608 can comprise said first sliding socket 608a and said second sliding socket 608b.

In one embodiment, said shade 102 can comprise said frame assembly 602.

In one embodiment, said hinge assemblies 106 can comprise said hinge slider and base assemblies 600 and said hinge socket 604.

In one embodiment, said hinges 604 can selectively attach said shade 102 to said chair 104. Further, said hinges 604 can allow said shade 102 to rotate relative to said chair 104. In one embodiment, said hinges 106 can be the same as said hinges 604.

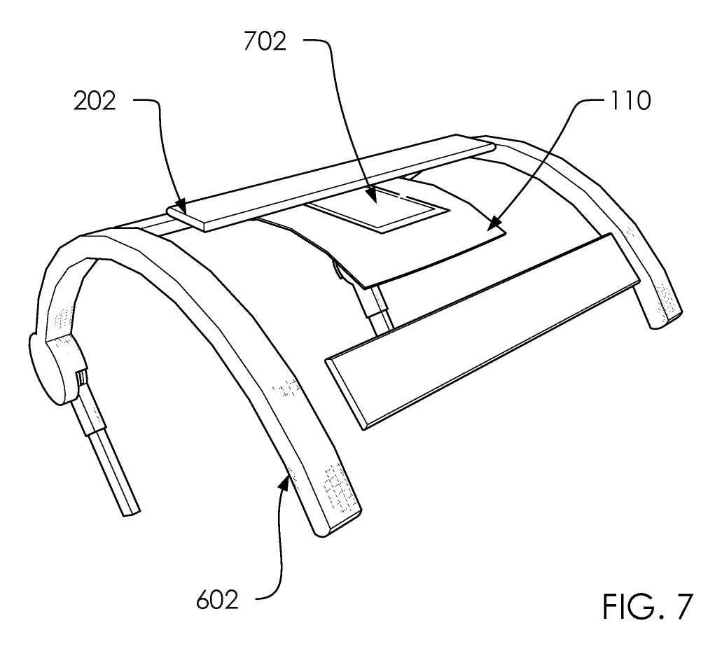

FIG. 7 illustrates a perspective overview view of a frame assembly 602.

Said pocket chair assembly 100 can selectively hold a thin computer 702, as illustrated. In one embodiment, said thin computer thin computer 702 can comprise a tablet, a smart phone or a hybrid computer being thin enough to slide into and out of said pocket 110, as is known in the art.

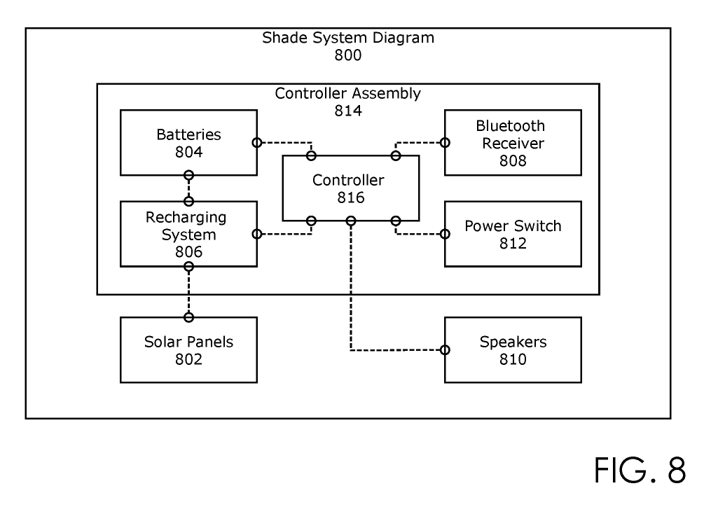

FIG. 8 illustrates a perspective overview of a shade system diagram 800.

In one embodiment, said shade system diagram 800 can comprise said solar panels 802, said batteries 804, said recharging system 806, said Bluetooth receiver 808, said speakers 810, said power switch 812, said controller assembly 814 and said controller 816.

In one embodiment, said speakers 810 can comprise said first speaker 810a and said second speaker 810b.

In one embodiment, said controller assembly 814 can comprise said batteries 804, said recharging system 806, said Bluetooth receiver 808, said power switch 812 and said controller 816.

In one embodiment, said shade 102 can comprise said shade system diagram 800.

In one embodiment, said canopy assembly 108 can comprise said solar panels 802, said batteries 804, said recharging system 806, said Bluetooth receiver 808, said speakers 810, said power switch 812 and said controller assembly 814.

The functionality of said lounge chair system diagram 800 would be obvious to one in the art, accordingly each of the parts described in this diagram may be hidden in the rendering of the system in other parts of the figures.

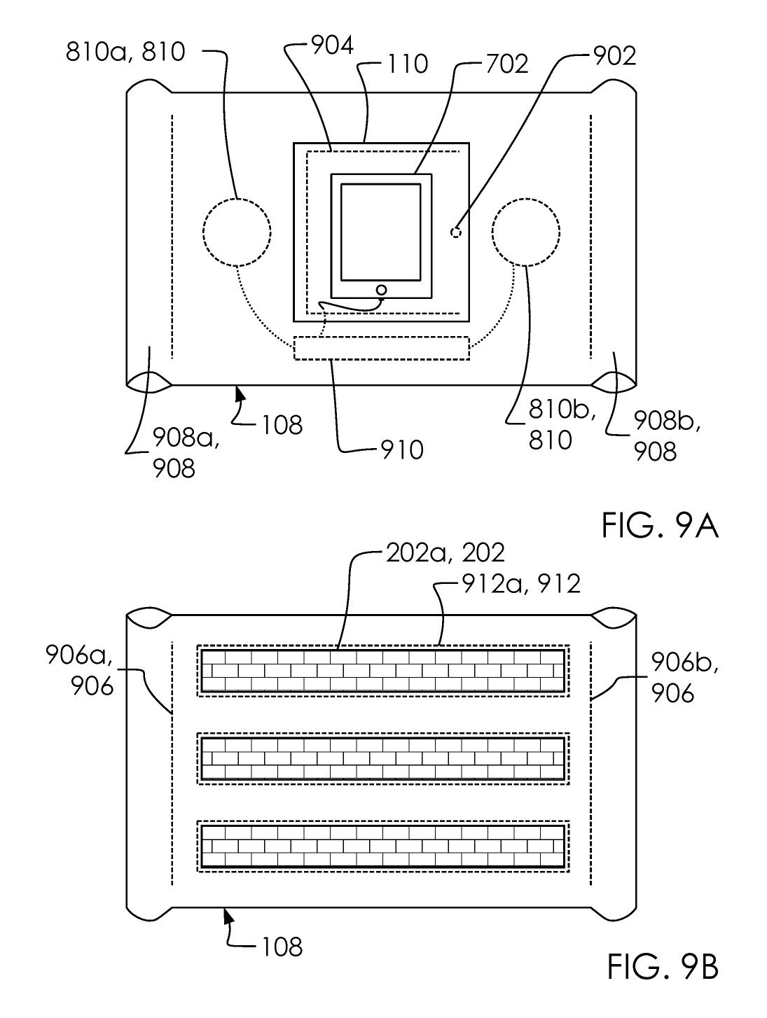

FIG. 9A illustrates an elevated bottom side view of a canopy assembly 108.

FIG. 9B illustrates an elevated top side view of a canopy assembly 108.

In one embodiment, said one or more sleeve stitching 906 can comprise said first sleeve stitching 906a and said second sleeve stitching 906b.

In one embodiment, said one or more sleeves 908 can comprise said first sleeve 908a and said second sleeve 908b.

In one embodiment, said shade 102 can comprise said pocket stitching 904 and said one or more sleeve stitching 906.

In one embodiment, said canopy assembly 108 can comprise said pocket stitching 904, said one or more sleeve stitching 906 and said one or more sleeves 908.

In one embodiment, said pocket 110 can comprise said clasp 902 and said pocket stitching 904.

Said canopy 108 can comprise said speakers 810 on either side of said pocket 110.

Said pocket 110 can be sewn into said canopy 108 with a pocket stitching 904 on three sides of said pocket 110. Said pocket 110 can further comprise a clasp 902 which can be selectively clasped to enclose said thin computer 702.

Said solar panels 202 can be selectively attached to a top side of said canopy 108.

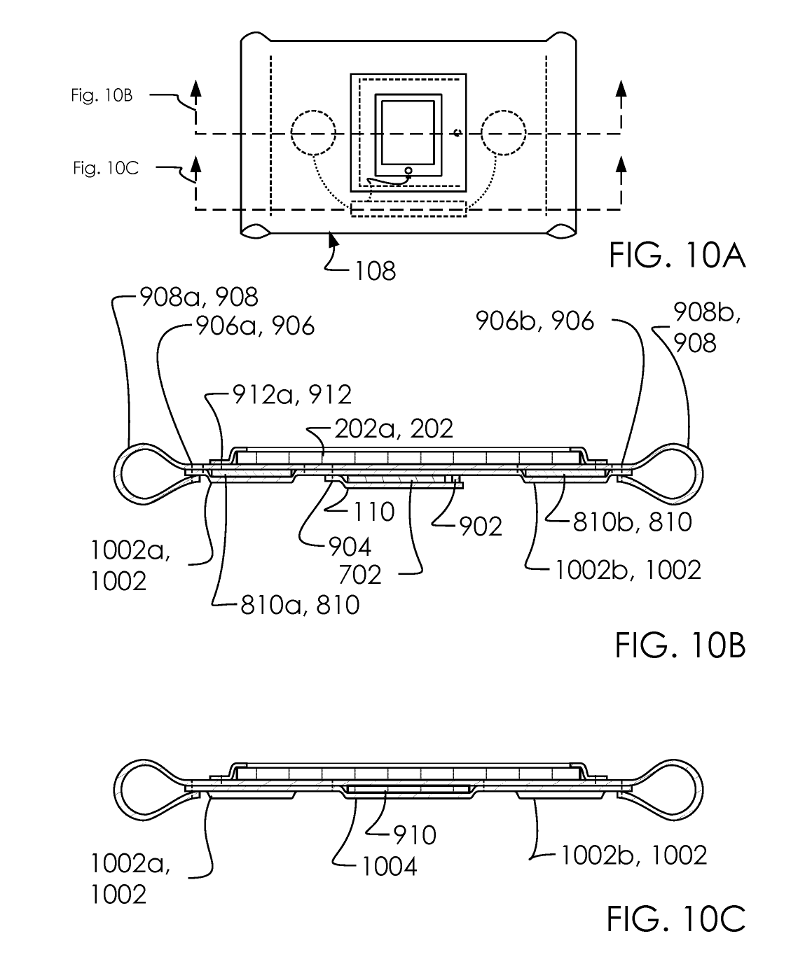

FIG. 10A illustrates an elevated bottom side view of a canopy assembly 108.

FIG. 10B illustrates an elevated front side view of a canopy assembly 108 in a first cross-section.

FIG. 10C illustrates an elevated front side view of a canopy assembly 108 in a second cross-section.

In one embodiment, said one or more speaker pockets 1002 can comprise said first speaker pocket 1002a and said second speaker pocket 1002b.

In one embodiment, said hinge assemblies 106 can comprise said controller pocket 1004.

In one embodiment, said canopy assembly 108 can comprise said 1000, said one or more speaker pockets 1002 and said controller pocket 1004.

The following sentences are included for completeness of this disclosure with reference to the claims.

Said controller assembly comprises a Bluetooth receiver and a speaker.

Said controller assembly comprises a solar panel and a battery.

Said recharging system is configured to selectively charge said thin computer.

Said canopy assembly comprises a moisture resistant fabric. Said controller assembly comprises a battery, a speaker and said controller. Said controller assembly is partially protected within a portion of said moisture resistant fabric. Said controller is configured to selectively attach to said thin computer.

A chair assembly is disclosed. Said chair assembly comprises a shade, a chair, an assembly and an upper frame extensions. Said hinge assemblies comprises a first hinge assembly and a second hinge assembly. Said shade comprises a canopy assembly, a pocket and a frame assembly. Said hinge assemblies comprises a hinge slider and base assemblies and a hinge socket. Said hinge socket selectively rotates on said hinge bases so as to move said canopy assembly in a range of linear positions. Said frame assembly comprises said hinge socket. Said canopy assembly comprises a top surface, a bottom surface and said pocket.

Said pocket selectively receives a thin computer for viewing and storage below on said bottom surface, and is partially translucent.

Said canopy assembly selectively attaches to said frame assembly and provides a selectively configured shade.

Said frame assembly selectively rotates on said hinge socket.

Said frame assembly comprises an arched shape.

Said frame assembly comprises a first side frame and a second side frame.

A sliding socket is configured to selectively slide on said upper frame extensions so as to extend or compress said shade relative to said chair.

Said hinge slider and base assemblies comprises a hinge bases and a sliding socket.

Said canopy assembly comprises a one or more sleeves.

Said canopy assembly is attached to said adjustable arms with said one or more sleeves.

A chair assembly is disclosed. Said chair assembly comprises a shade, a chair, a hinge assemblies and an upper frame extensions. Said hinge assemblies comprises a first hinge assembly and a second hinge assembly. Said shade comprises a canopy assembly, a pocket and a frame assembly. Said canopy assembly comprises a one or more sleeves. Said canopy assembly is attached to said adjustable arms with said one or more sleeves. Said hinge assemblies comprises a hinge slider and base assemblies and a hinge socket. Said hinge slider and base assemblies comprises a hinge bases and a sliding socket. Said sliding socket is configured to selectively slide on said upper frame extensions so as to extend or compress said shade relative to said chair. Said hinge socket selectively rotates on said hinge bases so as to move said canopy assembly in a range of linear positions. Said frame assembly comprises a first side frame and a second side frame. Said frame assembly comprises an arched shape. Said frame assembly comprises said hinge socket. Said frame assembly selectively rotates on said hinge socket. Said canopy assembly selectively attaches to said frame assembly and provides a selectively configured shade. Said canopy assembly comprises a top surface, a bottom surface and said pocket. Said canopy assembly. Said pocket selectively receives a thin computer for viewing and storage below on said bottom surface. Said pocket is partially translucent.

A controller assembly comprises a recharging system and a controller.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. The chair assembly of claim 12 wherein:
said controller assembly comprises a Bluetooth receiver and a speakers.

2. The chair assembly of claim 12 wherein:
said controller assembly comprises a solar panels and a batteries.

3. The chair assembly of claim 14 wherein:
said recharging system is configured to selectively charge said thin computer.

4. The chair assembly of claim 12 wherein:
said canopy assembly comprises a moisture resistant fabric;
said controller assembly comprises a batteries, a speakers and said controller;
said controller assembly is partially protected within a portion of said moisture resistant fabric; and
said controller is configured to selectively attach to said thin computer.

5. A chair assembly, wherein:
said chair assembly comprises a shade, a chair, a hinge assemblies and an upper frame extensions;
said hinge assemblies comprises a first hinge assembly and a second hinge assembly;
said shade comprises a canopy assembly, a pocket and a frame assembly;
said hinge assemblies comprises a hinge slider and base assemblies and a hinge socket;
said hinge socket selectively rotates on said hinge bases so as to move said canopy assembly in a range of linear positions;
said frame assembly comprises said hinge socket; and
said canopy assembly comprises a top surface, a bottom surface and said pocket.

6. The chair assembly of claim 1 wherein:
said pocket selectively receives a thin computer for viewing and storage below on said bottom surface, and is partially translucent.

7. The chair assembly of claim 1 wherein:
said canopy assembly selectively attaches to said frame assembly and provides a selectively configured shade.

8. The chair assembly of claim 1 wherein:
said frame assembly selectively rotates on said hinge socket.

9. The chair assembly of claim 1 wherein:
said frame assembly comprises an arched shape.

10. The chair assembly of claim 1 wherein:
said frame assembly comprises a first side frame and a second side frame.

11. The chair assembly of claim 1 wherein:
a sliding socket is configured to selectively slide on said upper frame extensions so as to extend or compress said shade relative to said chair.

12. The chair assembly of claim 1 wherein:
said hinge slider and base assemblies comprises a hinge bases and a sliding socket.

13. The chair assembly of claim 1 wherein:
said canopy assembly comprises a one or more sleeves.

14. The chair assembly of claim 1 wherein:
said canopy assembly is attached to said adjustable arms with said one or more sleeves.

15. A chair assembly, wherein:
said chair assembly comprises a shade, a chair, a hinge assemblies and an upper frame extensions;
said hinge assemblies comprises a first hinge assembly and a second hinge assembly;
said shade comprises a canopy assembly, a pocket and a frame assembly;
said canopy assembly comprises a one or more sleeves;
said canopy assembly is attached to said adjustable arms with said one or more sleeves;
said hinge assemblies comprises a hinge slider and base assemblies and a hinge socket;
said hinge slider and base assemblies comprises a hinge bases and a sliding socket;
said sliding socket is configured to selectively slide on said upper frame extensions so as to extend or compress said shade relative to said chair;
said hinge socket selectively rotates on said hinge bases so as to move said canopy assembly in a range of linear positions;
said frame assembly comprises a first side frame and a second side frame;
said frame assembly comprises an arched shape;
said frame assembly comprises said hinge socket;
said frame assembly selectively rotates on said hinge socket;
said canopy assembly selectively attaches to said frame assembly and provides a selectively configured shade;
said canopy assembly comprises a top surface, a bottom surface and said pocket;
said canopy assembly;
said pocket selectively receives a thin computer for viewing and storage below on said bottom surface; and
said pocket is partially translucent.

16. The chair assembly of claim 11 wherein:
a controller assembly comprises a recharging system and a controller.
